(19) United States
(12) Patent Application Publication
(10) Pub. No.: US 2010/0211687 A1
(43) Pub. Date: Aug. 19, 2010

(54) SYSTEMS AND METHODS FOR LOGGING USER INPUT DATA FOR SUBSEQUENT RETRIEVAL

(75) Inventors: Muhammed Jaber, Austin, TX (US); Fernando Meschino, Round Rock, TX (US); Frank Molsberry, Georgetown, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/371,797

(22) Filed: Feb. 16, 2009

(51) Int. Cl. G06F 15/173; G06F 15/177

(52) U.S. Cl. 709/228; 713/2

(57) ABSTRACT

An information handling system includes a processor, an authentication detection module, a user input device, and encoding module, and a buffer. The authentication detection module determines whether the information handling system is operating in an authenticated network communication session, The user input device receives user input data from a user, and the encoding module receives the user input data from the user input device and encodes the received user input data into a suitable format. The buffer logs the encoded user input data for later retrieval if the authentication detection module determines that the information handling system is not operating in an authenticated network communication session.

### TECHNICAL FIELD

The present disclosure relates in general to information handling systems, and more particularly to logging and user input data in an information handling system for subsequent retrieval (e.g., for forensic reconstruction or other purposes).

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Data security for information handling systems is an increasing concern for users. Individuals and owners often employ many measures for monitoring and protecting data stored on information handling systems including, for example, hardware and/or software techniques. For a network situation, such as a business environment data security is often monitored by a person, software, hardware or a combination thereof. Generally information handling systems connected to the network are secured and monitored handling system may be used to monitor systems connected to a network and their respective activities. However, once an information handling system is removed from the network, or worse, lost or stolen, it may be impossible to monitor the activities that may have taken place on that particular information handling system. In some instances data such as passwords, personal information, or other sensitive material may be compromised and/or used for illegal activities by an unauthorized user.

### SUMMARY

According to certain embodiments of the present disclosure, an information handling system includes a processor, an authentication detection module, a user input device, and encoding module, and a buffer. The authentication detection module determines whether the information handling system is operating in an authenticated network communication session. The user input device receives user input data from a user and the encoding module receives the user input data from the user input device and encodes the received user input data into a suitable format. The buffer logs the encoded user input data for later retrieval if the authentication detection module determines that the information handling system is not operating in an authenticated network communication session.

According to other embodiments of the present disclosure, a method for logging user input data in an information handling system for subsequent use is provided. The method includes determining that the information handling system is not operating in an authenticated network communication session, and in response to such determination, logging user input data received at the information handling system. Logging user input data received at the information handling system includes receiving user input data from a user via a user input device of the information handling system; encoding the user input data into a usable format; and logging the encoded user input data in a buffer in the information handling system such that the encoded user input data may be subsequently accessed.

According to other embodiments of the present disclosure, logic embodied in tangible computer-readable media of an information handling system is provided. The logic is configured, when executed by a processor, to determine that the information handling system is not operating in an authenticated network communication session. In response to such determination, the logic is configured to log user input data received at the information handling system. Logging user input data received at the information handling system includes receiving user input data from a user via a user input device of the information handling system; encoding the user input data into a usable format; and logging the encoded user input data in a buffer in the information handling system such that the encoded user input data may be subsequently accessed.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example information handling system configured to log user input data and retrieve the logged user input data (e.g., for forensic analysis or other purposes), in accordance with certain embodiments of the present disclosure;

FIG. 2 illustrates an example embodiment of the system of FIG. 1, in which the encoding and logging of user input data are performed by a microcontroller (e.g., an embedded controller);

FIG. 3 illustrates an example embodiment of the system of FIG. 1, in which the encoding and logging of user input data are performed by a basic input-output system (BIOS) or a unified extensible firmware interface (UEFI);

FIG. 4 illustrates an example method of managing the logging of user input data for subsequent retrieval, according to certain embodiments of the present disclosure), in accordance with certain embodiments of the present disclosure; and

FIG. 5 illustrates an example method of determining whether an information handling system is operating in an authenticated network communication session), in accordance with certain embodiments of the present disclosure; and

### DETAILED DESCRIPTION

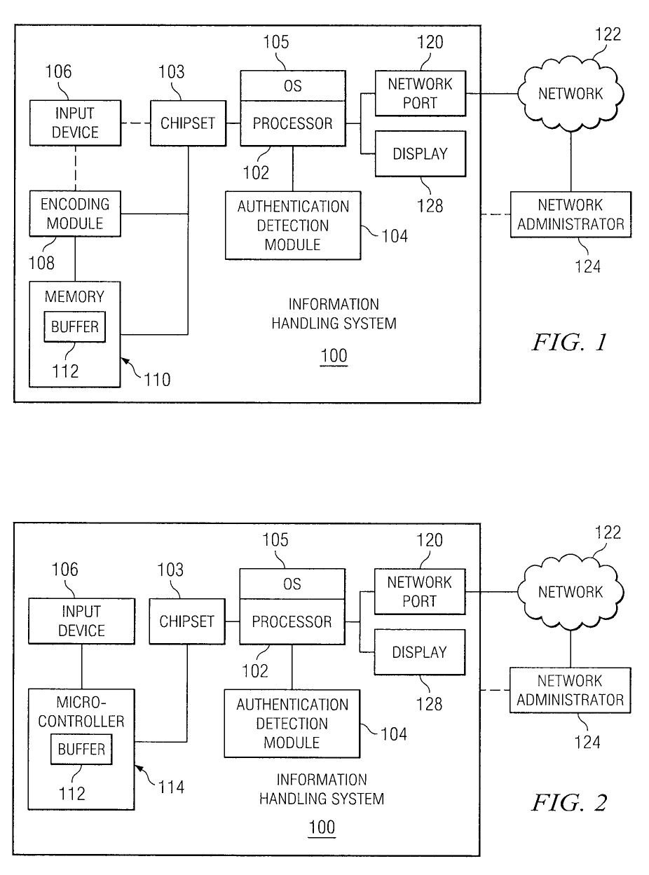

Preferred embodiments and their advantages are best understood by reference to FIGS. 1 through 5, wherein like numbers are used to indicate like and corresponding parts.

For the purposes of this disclosure, an information handling system may include any instrumentality or aggregate of instrumentalities configured to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a pointer device (e.g., mouse), and a video display. The information handling system may also include one or more buses configured to transmit communication between the various hardware components.

FIG. 1 illustrates an example information handling system 100 configured to log user input data and retrieve the logged user input data (e.g., for forensic analysis or other purposes), in accordance with certain embodiments of the present disclosure. As shown in FIG. 1, information handling system 100 may include a processor 102, a chipset 103, an authentication detection module 104, a user input device 106, an encoding module 108, a memory 110, a buffer 112, a display 118, and a network port 120.

Processor 102 may comprise any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data associated with authentication detection module 104, encoding module 108, memory 110, and/or other components of information handling system 100.

Processor 102 may host an operating system (OS) 105, e.g., any MICROSOFT WINDOWS™, MAC™, OR LINUX™ operating systems.

Chipset 103 may comprise a set of specialized chips on a motherboard or expansion card of system 100. For example, chipset 103 may include northbridge and/or southbridge chips.

Authentication detection module 104 is generally operable to determine whether system 100 is operating in an authenticated network communication session, which determination may then be used for determining whether to log user input data in buffer 112, as discussed below. In some embodiments, authentication detection module 104 is generally operable to determine whether or not system 100 is operating in a network communication session (e.g, whether system 100 is connected to the Internet, LAN, WAN, or other network), and if so, whether or not such network communication session is authenticated (e.g., based on username and password information entered by the user). Authentication detection module 104 may be communicatively coupled to processor 102 and may be embodied in hardware (e.g., system, device, apparatus, etc.) software, firmware, or any combination thereof.

User input devices 106 may comprise any one or more devices configured to receive user input data from a user, e.g., a keyboard, a pointing device (mouse, touch pad, trackball, etc.), a microphone, a touch screen, an image scanner, a webcam, and/or a barcode reader. User input data received via user input devices 106 may include, for example, keystrokes on a keyboard, clicks and/or scrolling from a pointing device, voice inputs from a microphone, tapping and/or dragging of a stylus from a touch screen, data from a scanned image, video from a webcam, and/or information code from a barcode scanner.

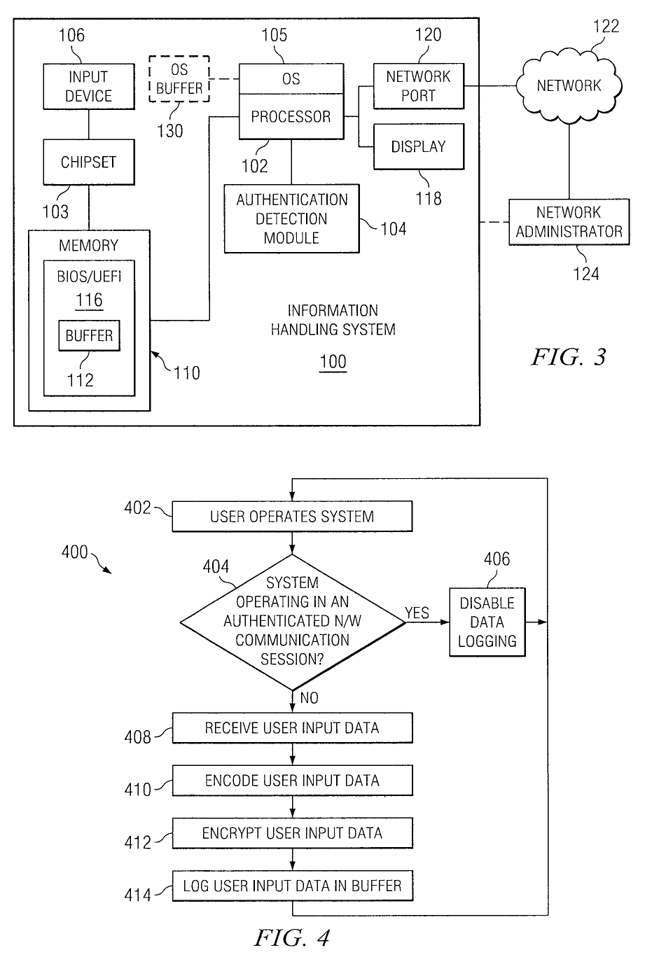

User input devices 106 may be communicate signals to system 100 in various manners. For example, one or more user input devices 106 may connect to a microcontroller, e.g., as shown in FIG. 2. As another example, one or more user input devices 106 may connect directly to chipset 103, e.g., via one or more USB ports provided by chipset 103, e.g., as shown in FIG. 3.

Encoding module 108 may be communicatively coupled to processor 102 and/or memory 114 and may be any hardware (e.g., system, device, apparatus, etc.) software, firmware, or any combination thereof configured to receive user input data via one or more user input devices 106 and convert the received user input data (e.g., keystrokes on a keyboard, clicks and scrolling from a pointer device, voice inputs from a microphone, tapping and/or dragging of a stylus from a touch screen, etc.) into a format suitable for storage (e.g., characters, instructions, code, bits, etc.). In some embodiments, encoding module 108 may also be configured to encrypt user input data received from user input device(s) 106, e.g., using any known or suitable encryption techniques or algorithms.

User input data encoded (and in some cases, encrypted) by encoding module 108 may be logged in buffer 112, depending on the current status of system 100 determined by authentication detection module 104, as discussed below.

In some embodiments, encoding module 108 may be implemented in a microcontroller (e.g., the embodiment of FIG. 2). In other embodiments, encoding module 108 may be implemented in a basic input-output system (BIOS) or a unified extensible firmware interface (UEFI) (e.g., the embodiment of FIG. 3).

Buffer, or “keystore,” 112 embodied in memory 110 is configured to log encoded (and/or encrypted) user input data from encoding module 108 if authentication detection module 104 determines that system 100 is not operating in an authenticated network communication session (e.g., system 100 is not operating in a network communication session or system 100 is operating in an unauthenticated network communication session). Buffer 112 may utilize any suitable types of data buffer techniques (e.g., FIFO) and may have any suitable data storage capacity. Buffer 112 may log encoded (and/or encrypted) user input data for later recovery by an authorized entity, e.g., a network administrator 124.

In some embodiments, buffer 112 may be implemented in a microcontroller (e.g., the embodiment of FIG. 2). In other embodiments, buffer 112 may be implemented in a basic input-output system (BIOS) or a unified extensible firmware interface (UEFI) (e.g., the embodiment of FIG. 3).

Memory 110 may be communicatively coupled to processor 102 and may comprise any system, device, or apparatus configured to retain program instructions or data for a period of time. In some embodiments, memory 110 may comprise non-volatile memory, e.g., electrically erasable programmable read-only memory (EEPROM), non-volatile random access memory (NVRAM), FLASH memory, magnetic storage, opto-magnetic storage, or any type of non-volatile memory. In some embodiments, memory 110 may also include volatile memory.

Display 118 may comprise any display device suitable for creating graphic images and/or alphanumeric characters recognizable to a user, and may include, for example, a liquid crystal display (LCD) or a cathode ray tube (CRT).

Network port 120 may be any suitable system, apparatus, or device configured to serve as an interface between information handling system 100 and other devices (e.g., network administrator 124) via a network 122. Network port 120 may enable network communications using any suitable transmission protocol and/or standard, including without limitation all transmission protocols and/or standards known in the art. In some embodiments, network port 120 may comprise a network interface card (NIC) or a LAN-on-motherboard (LOM).

Network 122 may be any suitable network and/or fabric for allowing network communications to/from system 100. Network 122 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 122 may transmit data using any known storage and/or communication protocols. Network 122 and its various components may be implemented using hardware, software, or any combination thereof.

Network administrator 124 may include any hardware, software, firmware, or a combination thereof configured to connect to system 100 via network 122 for access to system 100. In some embodiments, network administrator 124 may be a web-client processor that interfaces with processor 102 via a wired or wireless network. In other embodiments, network administrator 124 may also be an information handling system configured to execute a scriptable interface such as RACADM or a server management command line protocol (SMCLP) to connect to system 100. In some embodiments, network administrator 124 may be configured to connect directly to system 100 (e.g., using a wireless or wired connection) without the use of a network.

In operation, the components of system 100 function to determine the operational status of system 100 (e.g., whether or not system 100 is operating in an authenticated network communication session), and enable or disable the logging of user input data (e.g., keystrokes) based on the determined operational status.

In some embodiments, when system 100 is powered on, authentication detection module 104 determines whether system 100 is operating in an authenticated network communications session. For example, authentication detection module 104 may determine that system 100 is operating in an authenticated network communications session when information handling system 100 is connected to an authenticated network 122 (e.g., a company LAN for which system 100 is authenticated) and/or network administrator 124, and the user has been authenticated (e.g., by entering a valid username and password). Conversely, authentication detection module 104 may determine that system 100 is not operating in an authenticated network communications session when, e.g., information handling system 100 is not connected to an authenticated network 122 and/or network administrator 124 (e.g., where system 100 is connected to a non-authenticated network 122), system 100 is determined to be stolen, a network 122 failure, system 100 is removed from an authenticated network 122, a network administrator 124 system failure, a power failure, etc. In some instances, authentication detection module 104 may attempt to authenticate a network communications session based on user authentication data (e.g., key, code, password, fingerprint scan, palm scan, retinal scan, voice scan, etc.) received from the user via user input device 106.

Based on whether authentication detection module 104 detects that system 100 is operating in an authenticated network communications session, processor 102 may control the logging of user input data in buffer 112 accordingly. For example, if module 104 determines that system 100 is operating in an authenticated network communications session, processor 102 may disable buffering of user input data. Conversely, if module 104 determines that system 100 is not operating in an authenticated network communications session (e.g., system 100 is connected to a non-authenticated network 122 or system 100 is not connected to a network at all), processor 102 may enable buffering of user input data. For example, authentication detection module 104 may notify processor 102 to begin logging (or continue to log) some or all user input data after a failed user authentication attempt has been received (e.g., invalid key, code, password, fingerprint scan, palm scan, retinal scan, voice scan, etc.). In addition, in some embodiments, an anti-theft software installed on system 100 or in communication with system 100 via a network 122 may detect illegal or unauthorized use of system 100, and notify authentication detection module 104.

Authentication detection module 104 may continue to monitor the operational status of system 100 after startup in order to detect changes in the operational status, and control (e.g., enable/disable) the logging of user input data in buffer 112 accordingly. For example, if during use of system 100, a user initiates an authenticated network communication session (e.g., an authorized user of system 100 logging into their company LAN), authentication detection module 104 may detect this change in status and notify processor 102 to disable the (currently enabled) logging of user input data. Similarly, if during use of system 100, a user disconnects from an authenticated network communication session (e.g., a user of system 100 disconnects from their company LAN), authentication detection module 104 may detect this change in status and notify processor 102 to enable the (currently disabled) logging of user input data.

In some embodiments, in addition or as an alternative to controlling the enabling/disabling of user input data logging, processor 102 may control an overwrite rule, a buffer size for buffer 112, and/or any other parameter or rule regarding the logging of user input data based on the determinations made by authentication detection module 104. For example, processor 102 may (a) if system 100 is operating in an authenticated network communications session, enable logging of user input data, but overwrite logged data in buffer 112 once buffer 112 fills up, and (b) if system 100 is not operating in an authenticated network communications session, enable logging of user input data and automatically increase the size of buffer 112 in order to log more data.

As another example, processor 102 may (a) if system 100 is operating in an authenticated network communications session, enable logging of user input data, but allow overwriting of logged data in buffer 112 once buffer 112 fills up, and (b) if system 100 is not operating in an authenticated network communications session, enable logging of user input data and disable overwriting of logged data in buffer 112 such that the user input data stored during the beginning of the non-authenticated session is preserved (i.e., not overwritten by later received user input data).

FIG. 2 illustrates an example embodiment of system 100 in which encoding module 108 and buffer 112 are embodied in a microcontroller 114. Microcontroller 114 (which may be an embedded controller, or “EC”) may be implemented using hardware, software (e.g., operating system), firmware, or any combination thereof. Microcontroller 114 may be configured to receive user input data via one or more user input devices 106 (e.g., keyboard, mouse, etc.), encode the received user input data to a usable format (e.g., characters, instructions, code, bits, etc.), and log the encoded data in buffer 112, depending on the operational status of system 100 (as determined by authentication detection module 104). Microcontroller 114 may also encrypt user input data to be logged in buffer 112.

As shown in FIG. 2, such configuration may be suitable for encoding and logging user input data received via input devices 106 connected to microcontroller 114 (rather than directly connected to chipset 103).

FIG. 3 illustrates an example embodiment of system 100 in which encoding module 108 and buffer 112 are embodied in a basic input-output system (BIOS) or a unified extensible firmware interface (UEFI) 116, referred to herein as BIOS/UEFI 116. BIOS/UEFI 116 may be configured to receive user input data via one or more user input devices 106 (e.g., keyboard, mouse, etc.), encode the received user input data to a usable format (e.g., characters, instructions, code, bits, etc.), and log the encoded data in buffer 112, depending on the operational status of system 100 (as determined by authentication detection module 104). BIOS/UEFI 116 may also encrypt user input data to be logged in buffer 112.

As shown in FIG. 3, such configuration may be suitable for encoding and logging user input data received via input devices 106 connected directly to chipset 103, e.g., via one or more USB ports provided by chipset 103.

In some embodiments, the encoding and buffering are initially handled by BIOS/UEFI 116 during a system boot, and then handed over to operating system (OS) 105. For example, during the boot process, BIOS/UEFI 116 may handle USB input devices 106, including encoding and logging user input data, when appropriate. Once BIOS/UEFI 116 hands off control to OS 105, OS 105 takes over the capability to handle USB input devices 106. Thus, system 100 may include an OS buffer 130 (e.g., software-based) having a driver interface with BIOS/UEFI 116. After OS 105 has taken control from BIOS/UEFI 116, OS 105 may encode user input data (e.g., keystrokes) and send such data to OS buffer 130, as well as any application that should receive such user input data. OS buffer 130 may then send the encoded user input data to BIOS/UEFI 116 for storing in BIOS/UEFI buffer 112 (or in an alternative embodiment, to a buffer hosted by a microcontroller 114).

In some embodiments in which encoding module 108 and buffer 112 are embedded in BIOS or UEFI 116, the embedded encoding module 108 and/or buffer 112 may ensure that any relevant OS level modules (e.g., OS buffer 130) are reinstalled after a situation in which the OS (HDD) is wiped out.

FIG. 4 illustrates an example method 400 of managing the logging of user input data for subsequent retrieval, according to certain embodiments of the present disclosure. At step 402, a user operates an information handling system 100 (e.g., a laptop or PDA). At step 404, authentication detection module 104 determines whether or not system 100 is operating in an authenticated network communication session.

Depending on this determination, processor 102 may control the logging of user input data received from the user accordingly. For example, if system 100 is operating in an authenticated network communication session, processor 102 may disable the logging of user input data. If system 100 is not operating in an authenticated network communication session, processor may enable data logging and the method may proceed to steps 408-414. At step 408, system 100 receives user input data via one or more input devices 106. At step 410, encoding module 108 encodes the user input data. At optional step 412, encoding module 108 may encrypt the encoded user input data. At step 414, the encoded and/or encrypted user input data is logged in buffer 112.

In some embodiments, a particular logging policy may be selected for system 100 from multiple available logging policies, either manually by a user (e.g., a network administrator) or automaticaly (e.g., by procesor 102). For example, the logging policy for system 100 may select may be selected from the following logging policies:

(a) user input data is always logged;

(b) user input data is automatically logged when triggered by an anti-theft application (local to or remote from system 100);

(c) user input data is automatically logged when system 100 is not operating in an authentication network communication session, e.g., as discussed above;

(d) user input data is automatically logged when (a) triggered by an anti-theft application (local to or remote from system 100 or (b) system 100 is not operating in an authentication network communication session; and

(e) any other logging policy.

The logging policy implemented on system 100 may be changed over time, e.g., if system 100 is reassigned to a new end user. In some embodiments, the logging policy for each of a group of systems 100 may be selected based on the known end user each system 100. For example, processor 102 may automatically select a logging policy for each of a group of systems 100 based on data available to processor 102 regarding the end users of systems 100, e.g., using any suitable selection rules, which may be designed by an administrator as desired.

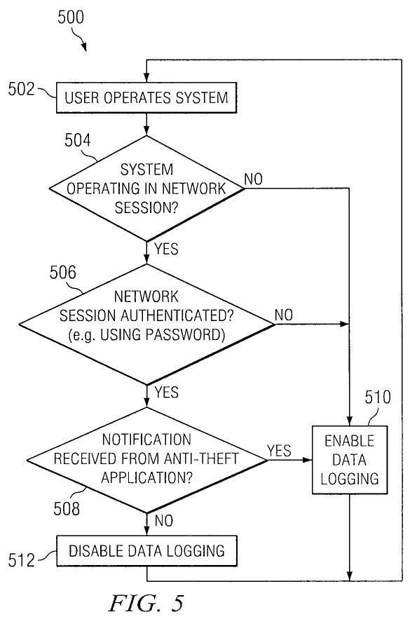

FIG. 5 illustrates an example method 500 implementing logging policy (d) for a particular system 100 (i.e., where user input data is automatically logged when (a) triggered by an anti-theft application (b) system 100 is not operating in an authentication network communication session). At step 502, a user operates an information handling system 100 (e.g., a laptop or PDA).

At step 504, authentication detection module 104 determines whether system 100 is operating in a network session (e.g., whether system 100 is connected to a network). If so, the method may proceed to step 506. If not, the method may proceed to step 510, discussed below.

At step 506, authentication detection module 104 determines whether the network session is authenticated. Module 104 may make such authentication determination based on authentication data (e.g., username and password) received from the user of system 100. In some embodiments, module 104 may receive a notification (e.g., a key or password) remotely via network 122 indicating whether system 100 is engaged in an authenticated or non-authenticated network session. For example, a network login management server may receive a username and password from the user via network 122, determine whether to authenticate the user, and notify module 104 (via network 122) of the results. If module 104 determines that the network session is not authenticated, the method may proceed to step 510, discussed below. If module 104 determines that the network session is authenticated, the method may proceed to step 508.

At step 508, authentication detection module 104 determines a notification from an anti-theft application (either local to or remote from system 100) has been received, indicating that system 100 is stolen or being used by an unauthorized user. If so, the method may proceed to step 510, discussed below. If not, the method may proceed to step 512, also discussed below.

At step 510, in response to determining that (a) system 100 is not engaged in a network session, (b) system 100 is engaged in a non-authenticated network session, and/or (c) module 104 has received a notification from an anti-theft application, processor 102 may enable the logging of user input data in buffer 112.

At step 512, in response to determining that (a) system 100 is engaged in a network session, (b) the network session is authenticated, and (c) module 104 has not received a notification from an anti-theft application, processor 102 may disable the logging of user input data.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor;
an authentication detection module coupled to the processor and configured to determine whether the information handling system is operating in an authenticated network communication session;
a user input device configured to receive user input data from a user;
an encoding module configured to receive the user input data from the user input device and encode the received user input data into a suitable format; and
a buffer configured to log the encoded user input data for later retrieval if the authentication detection module determines that the information handling system is not operating in an authenticated network communication session.

2. The information handling system of claim 1, wherein the buffer is configured to not log the encoded user input data if the authentication detection module determines that the information handling system is operating in an authenticated network communication session.

3. The information handling system of claim 1, wherein the authentication detection module determines whether the information handling system is operating in an authenticated network communication session based at least on user authentication data received from the user via the user input device.

4. The information handling system of claim 1, wherein the encoding module is configured to encrypt the user input data received from the user.

5. The information handling system of claim 1, wherein the authentication detection module is configured to determine that the information handling system is not operating in an authenticated network communication session if either:
the information handling system is not operating in a network communication session; or
the information handling system is operating in a network communication session that is not authenticated.

6. The information handling system of claim 1, wherein the authentication detection module is configured to determine that the information handling system is not operating in an authenticated network communication session in response to receiving a notification from an anti-theft application via a network.

7. The information handling system of claim 1, wherein the encoding module configured to receive and encode the user input data may comprise a microcontroller coupled to the processor.

8. The information handling system of claim 1, wherein the encoding module configured to receive and encode the user input data further may be provided by a basic input-output system (BIOS) or a unified extensible firmware interface (UEFI) located in a memory storage device.

9. The information handling system of claim 1, wherein the buffer configured to log the encoded user input data is stored in non-volatile memory associated with a basic input-output system (BIOS), a unified extensible firmware interface (UEFI), or a controller.

10. The information handling system of claim 1, wherein the user input device configured to receive user input data may comprise at least one of a keyboard, a pointing device, a microphone, an image scanner, a webcam, and a barcode reader.

11. A method for logging user input data in an information handling system for subsequent use, the method comprising:
determining that the information handling system is not operating in an authenticated network communication session; and
in response to determining that the information handling system is not operating in an authenticated network communication session, logging user input data received at the information handling system, wherein logging user input data received at the information handling system includes:
receiving user input data from a user via a user input device of the information handling system;
encoding the user input data into a usable format; and
logging the encoded user input data in a buffer in the information handling system such that the encoded user input data may be subsequently accessed.

12. The method of claim 11, further comprising:
determining that the information handling system is operating in an authenticated network communication session; and
not logging user input data in the buffer while the information handling system is operating in an authenticated network communication session.

13. The method of claim 11, wherein determining that the information handling system is not operating in an authenticated network communication session includes analyzing user authentication data received from the user via the user input device of the information handling system.

14. The method of claim 11, wherein encoding the user input data into a usable format includes encrypting the user input data.

15. The method of claim 11, further comprising:
establishing a connection between the information handling system and a network administrator;
receiving from the network administrator a request to access the encoded user input data logged in the buffer; and
providing the network administrator access to the encoded user input data logged in the buffer.

16. The method of claim 11, wherein determining that the information handling system is not operating in an authenticated network communication session comprises one of:
determining that the information handling system is not operating in a network communications session; and
determining that the information handling system is operating in a network communications session that is not authenticated.

17. The method of claim 11, further comprising:
receiving a notification from an anti-theft application via a network; and
determining that the information handling system is not operating in an authenticated network communication session based on the received notification from the anti-theft application.

18. Logic embodied in tangible computer-readable media of an information handling system and when executed by a processor, configured to:
determine that the information handling system is not operating in an authenticated network communication session; and
in response to determining that the information handling system is not operating in an authenticated network communication session, log user input data received at the information handling system, wherein logging user input data received at the information handling system includes:
receiving user input data from a user via a user input device of the information handling system;
encoding the user input data into a usable format; and
logging the encoded user input data in a buffer in the information handling system such that the encoded user input data may be subsequently accessed.

19. The logic of claim 18, further configured to:
determine that the information handling system is operating in an authenticated network communication session; and
not log user input data in the buffer while the information handling system is operating in an authenticated network communication session.

20. The logic of claim 18, wherein determining that the information handling system is not operating in an authenticated network communication session comprises one of:
determining that the information handling system is not operating in a network communications session;
determining that the information handling system is operating in a network communications session that is not authenticated; and
receiving a notification from an anti-theft application via a network.
